(19) United States
(12) Patent Application Publication
(10) Pub. No.: US 2015/0086046 A1
(43) Pub. Date: Mar. 26, 2015

(54) FEEDBACK PROVIDING MODULE, FEEDBACK PROVIDING APPRATUS, AND FEEDBACK PROVIDING METHOD

(71) Applicant: ELECTRONICS AND TELECOMMUNICATIONS RESEARCH INSTITUTE, Daejeon (KR)

(72) Inventors: Chang-Mok OH, Daejeon (KR); Jong-Uk LEE, Daejeon (KR); Min-Kyu KIM, Daejeon (KR); Jun-Seok PARK, Daejeon (KR); Hee-Sook SHIN, Daejeon (KR); Jeong-Mook LIM, Daejeon (KR); Hyun-Tae JEONG, Daejeon (KR)

(73) Assignee: ELECTRONICS AND TELECOMMUNICATIONS RESEARCH INSTITUTE, Daejeon (KR)

(21) Appl. No.: 14/337,790

(22) Filed: Jul. 22, 2014

(30) Foreign Application Priority Data
Sep. 25, 2013 (KR) 10-2013-0114102

(51) Int. Cl. H04R 17/00; G08B 3/10; G06F 3/01

(52) U.S. Cl. CPC H04R 17/00; G06F 3/016; G08B 3/10; H04R 2400/03; H04R 2499/11
USPC 381/151

(57) ABSTRACT

Disclosed herein are a feedback providing module, a feedback providing apparatus, and a feedback providing method. The feedback providing module includes: an upper plate part generating a vibration; a lower plate part inducing the vibration of the upper plate part; and a feedback controlling unit applying first to fourth voltages having different levels to the upper and the lower plate part in response to feedback control signals and varying the levels of the first to fourth voltages to control the upper and the lower plate part to generate at least one of a sound and a vibration.

### CROSS REFERENCE TO RELATED APPLICATION

This application claims the benefit of Korean Patent Application No. 10-2013-0114102, filed on Sep. 25, 2013, entitled “Feedback Providing Module, Feedback Providing Apparatus, and Feedback Providing Method”, which is hereby incorporated by reference in its entirety into this application.

### BACKGROUND OF THE INVENTION

1. Technical Field

The present invention relates to a feedback providing module, a feedback providing apparatus, and a feedback providing method, and more particularly, to a feedback providing module capable of being implemented as a thin film and simultaneously providing a sound and a vibration, and a feedback providing apparatus and a feedback providing method.

2. Description of the Related Art

When an apparatus that does not include a mechanical input means according to the related art, but includes an electronic input means capable of performing an user input using a touch screen, a camera, or the like, does not separately include a means for providing a physical feedback for a user operation, it is difficult to a user to accurately judge whether the input is accurately performed, such that the user experiences inconvenience in using the corresponding apparatus.

In order to solve this problem, it is general to provide a visual queue or provide an appropriate feedback corresponding to the user input through a sound, a vibration, or the like.

FIG. 1 shows an example of a feedback providing apparatus for providing a feedback corresponding to a user input according to the related art.

In the feedback providing apparatus 100 according to the related art that includes a touch screen 11 as an input means and provides a feedback for a user input through a sound, a vibration, or the like, a speaker 15, a vibration motor 16, and the like, have been used as a feedback providing module provided in order to provide a feedback for a user input in the case in which the user input is generated on the touch screen 11 or is generated through a camera 12, as shown in FIG. 1. However, since modules such as the speaker 15 and the vibration motor 16 according to the related art may not be implemented as a thin film, they are provided separately from a display means, and it is likely that they will be biased and disposed at one side end of the apparatus, such that it is difficult to provide a uniform feedback. Further, in the case of an apparatus having a large size, a difference between an input position of a user and a position of the feedback providing apparatus occurs, such that the feedback may not be actually felt well.

Furthermore, since two modules, that is, the speaker 15 and the vibration motor 16 are provided, in the case of a small apparatus having a large constraint on a size such as a tablet personal computer (PC) or a smart phone, it is difficult to secure a space in which the speaker 15 and the vibration motor 16 are included, such that a design and manufacturing cost may rise.

In addition, although a large apparatus such as a surface display apparatus or a wall display apparatus that has been recently spread is configured so that it may be simultaneously used by multiple users, the exiting apparatus in which positions of the speaker 15 and the vibration motor 16, which are the feedback providing module, are limited, as shown FIG. 1, may not specify a target to which the feedback is to be provided through the sound and the vibration.

### SUMMARY OF THE INVENTION

An object of the present invention is to provide a feedback providing module capable of being easily included in an apparatus such as a surface display or a wall display and simultaneously providing a sound and a vibration.

Another object of the present invention is to provide a feedback providing apparatus for accomplishing the above-mentioned object.

Still another object of the present invention is to provide a feedback providing method for accomplishing the above-mentioned object.

According to an exemplary embodiment of the present invention, there is provided a feedback providing module including: an upper plate part including a film formed of a transparent piezoelectric material and generating a vibration through a change in a shape of the film formed of the transparent piezoelectric material when first and second voltages are applied to upper and lower surfaces of the film, respectively; a lower plate part disposed so as to be spaced apart from a lower surface of the upper plate part and inducing the vibration of the upper plate part using a voltage difference between a third voltage and a fourth voltage when the fourth voltage is applied thereto in order to generate a voltage difference from the third voltage applied to the upper plate part; and a feedback controlling unit applying the first to fourth voltages having different levels to the upper plate part and the lower plate part in response to feedback control signals and varying the levels of the first to fourth voltages to control the upper plate part and the lower plate part to generate at least one of a sound and a vibration.

The feedback providing module may further include a supporting structure inserted between the upper plate part and the lower plate part to support the upper plate part in a state in which the upper plate part and the lower plate part are spaced apart from each other by a preset interval. Wherein a size of an empty areas surrounded by the supporting structure may be adjusted for guaranteeing a performance within target frequency range of sound or vibration. Wherein the supporting structure may be composed of adhesive materials and non-adhesive materials.

The upper plate part may include: an upper plate transparent film implemented as the film formed of the transparent piezoelectric material; an upper plate upper surface transparent electrode disposed on an upper surface of the upper plate transparent film and receiving the first voltage; and an upper plate lower surface transparent electrode disposed on a lower surface of the upper plate transparent film and receiving the second and third voltages.

The lower plate part may include: a lower plate transparent film formed of a transparent non-conductor; and a lower plate lower surface transparent electrode disposed on a lower surface of the lower plate transparent film and receiving the fourth voltage.

The feedback providing module may further comprise an insulating layer on an upper plate upper surface transparent electrode and an insulating layer beneath the lower plate lower surface transparent electrode.

The feedback controlling unit may include: a sound controller controlling the first and second voltage so that the upper plate transparent film vibrates in an audio frequency range, in response to a sound feedback control signal among the feedback control signals; and a vibration controller controlling the third and fourth voltage so that the upper plate transparent film vibrates at a low frequency lower than the audio frequency range, in response to a vibration feedback control signal among the feedback control signals.

According to another exemplary embodiment of the present invention, there is provided a feedback providing apparatus including a feedback providing unit including at least one feedback providing module as described above; an input means sensing a user input to generate an input signal; a recognizing unit receiving and analyzing the input signal and generating recognized information for providing a feedback from the input means; and a controlling unit judging a preset feedback mode when the recognized information is received and transmitting a feedback control signal depending on the feedback mode to the feedback providing unit.

The feedback providing unit may include a plurality of feedback providing modules disposed in a lattice form or in a row. Wherein a size of at least one of the plurality of feedback providing modules may be different from that of the other feedback providing modules.

The plurality of feedback providing modules may generate sounds and vibrations having different patterns, respectively.

According to still another exemplary embodiment of the present invention, there is provided a feedback providing method by a feedback providing apparatus including a feedback providing unit including at least one feedback providing module including an upper plate transparent film implemented as a film formed of a transparent piezoelectric material and a lower plate transparent film formed of a non-conductor and disposed so as to be spaced apart from the upper plate transparent film to generate a sound and a vibration, an input means, a recognizing unit, and a controlling unit, including: judging, by the recognizing unit, whether an input signal generated by the input means sensing an user input is received; analyzing, by the recognizing unit, the input signal when the input signal is received, to transmit recognized information for providing a feedback; judging, by the controlling unit, a preset feedback mode of the feedback providing apparatus when the recognized information is received; transmitting, by the controlling unit, a feedback control signal depending on the judged feedback mode; generating, by the feedback providing unit, a sound feedback by applying and controlling first and second voltages having different levels to upper and lower surfaces of the upper plate transparent film, respectively, in response to a sound feedback control signal included in the feedback control signal; and generating, by the feedback providing unit, a vibration feedback by applying and controlling third and fourth voltages having different levels to the lower surface of the upper plate transparent film and a lower surface of the lower plate transparent film, respectively, in response to a vibration feedback control signal included in the feedback control signal.

The generating of the sound feedback may include: judging, by a sound controller included in the feedback providing module, whether the sound feedback control signal is received from the controlling unit; applying, by the sound controller, the first voltage to an upper plate upper surface transparent electrode disposed on the upper surface of the upper plate transparent film in response to the sound feedback control signal when the sound feedback control signal is received; applying, by the sound controller, the second voltage to an upper plate lower surface transparent electrode disposed on the lower surface of the upper plate transparent film; and varying, by the sound controller, a voltage difference between the first and second voltages so that the upper plate transparent film vibrates in an audio frequency range.

The generating of the vibration feedback may include: judging, by a vibration controller included in the feedback providing module, whether the vibration feedback control signal is received from the controlling unit; applying, by the vibration controller, the third voltage to the upper plate lower surface transparent electrode in response to the vibration feedback control signal when the vibration feedback control signal is received; applying, by the vibration controller, the fourth voltage to a lower plate lower surface transparent electrode disposed on the lower surface of the lower plate transparent film; and varying, by the vibration controller, a voltage difference between the third and fourth voltages so that the upper plate transparent film vibrates at a low frequency lower than the audio frequency range.

In the transmitting of the feedback control signal, in the case in which the feedback providing unit includes a plurality of feedback providing modules, the controlling unit may transmit different feedback control signals to the plurality of feedback providing modules, respectively, so that the plurality of feedback providing modules provide feedbacks having different patterns, respectively.

### BRIEF DESCRIPTION OF THE DRAWINGS

FIG. 1 shows an example of a feedback providing apparatus for providing a feedback corresponding to a user input according to the related art;

FIG. 2 shows a feedback providing apparatus for providing a feedback corresponding to a user input according to an exemplary embodiment of the present invention;

FIG. 3 is an exploded perspective view showing a detailed structure of a feedback providing module of FIG. 2;

FIG. 4 is an assembled perspective view of the feedback providing module of FIG. 3;

FIG. 5 is a cross-sectional view of the feedback providing module of FIG. 3;

FIGS. 6 and 7 show another example of a feedback providing apparatus using the feedback providing module according to an exemplary embodiment of the present invention;

FIG. 8 is a flow chart showing a feedback providing method for providing a feedback corresponding to a user input according to an exemplary embodiment of the present invention; and

FIG. 9 is an exploded perspective view showing a detailed structure of supporting structure according to an exemplary embodiment of the present invention.

### DESCRIPTION OF EXEMPLARY EMBODIMENTS

In order to sufficiently understand the present invention, operational advantages of the present invention, and objects accomplished by exemplary embodiments of the present invention, the accompanying drawings showing exemplary embodiments of the present invention and contents described in the accompanying drawings should be referred.

Hereinafter, exemplary embodiments of the present invention will be described in detail with reference to the accompanying drawings. However, the present invention may be implemented in several different forms and is not limited to exemplary embodiments provided in the present specification. In addition, in order to clearly describe the present invention, portions that are not associated with a description will be omitted, and the same components will be denoted by the same reference numerals.

Throughout the present specification, unless explicitly described to the contrary, “comprising” any components will be understood to imply the inclusion of other elements rather than the exclusion of any other elements. A term “part”, “-er/or”, “apparatus”, “block”, or the like, described in the specification means a processing unit of at least one function or operation and may be implemented by hardware or software or a combination of hardware and software.

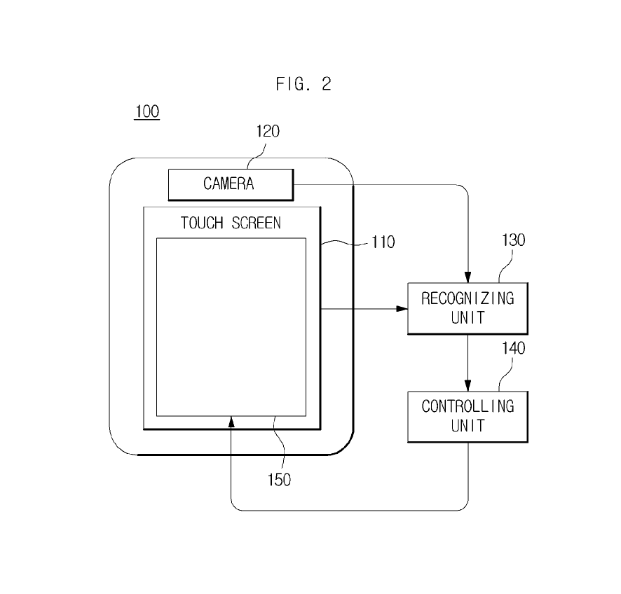

FIG. 2 shows a feedback providing apparatus for providing a feedback corresponding to a user input according to an exemplary embodiment of the present invention.

The feedback providing apparatus 100 of FIG. 2 is configured to include a touch screen 110, a camera 120, a recognizing unit 130, a controlling unit 140, and a feedback providing unit 150. The touch screen 110 and the camera 120, which are input means, receive a user command. The touch screen 110 may include a plurality of touch sensors (not shown) to sense a touch of a user and may transmit a touch sensing signal as an input signal to the recognizing unit 130. The touch sensing signal may include information on a position on the touch screen touched by the user and information on touch strength. The camera 120 may include an image sensor (not shown) to acquire an image and may transmit the acquired image as an input signal to the recognizing unit 130.

Although the case in which the feedback providing apparatus 100 includes both of the touch screen 110 and the camera 120 has been shown in FIG. 2, the feedback providing apparatus 100 may include at least one of the touch screen 110 and the camera 120 and may include other input means. That is, the feedback providing apparatus 100 according to an exemplary embodiment of the present invention may include all kinds of electronic input means that need to separately provide a feedback, except for a mechanical input means according to the related art that may directly provide a feedback, as input means.

The recognizing unit 130 may analyze the input signal applied from the touch screen 110 and the camera 120 to judge whether or not the input signal is a preset user command. In addition, when it is judged that the input signal is the user command, the recognizing unit 130 transmits the user command to the controlling unit 140. In addition, the recognizing unit 130 transmits position information, touch strength information, and image analyzing information acquired by analyzing the input signal as recognized information to the controlling unit 140.

The controlling unit 140 receives the user command and the recognized information and performs an operation corresponding to the received user command. Particularly, the controlling unit 140 according to an exemplary embodiment of the present invention controls the feedback providing unit 150 to provide a feedback responding to the recognized information to the user when the recognized information is applied thereto. The controlling unit 140 receives the recognized information from the recognizing unit 130 to control the feedback providing unit 150. However, in some cases, the controlling unit 140 may also directly receive the input signal and analyze the input signal to obtain the position information, the touch strength information, and the image analyzing information, thereby transmitting a feedback control signal corresponding to the input signal to the feedback providing unit 150. Particularly, the controlling unit 140 may judge whether a preset mode of the feedback providing apparatus 100 is a vibration feedback mode or a sound feedback mode to transmit the feedback control signal so that the feedback providing unit 150 may selectively provide one of a sound feedback and a vibration feedback and transmit the feedback control signal so that the feedback controlling unit 150 may simultaneously provide the sound feedback and the vibration feedback in a sound and vibration feedback mode. For example, the controlling unit 140 may separately transmit a sound feedback control signal and a vibration feedback control signal to the feedback providing unit 150. Further, in some cases, the controlling unit 140 may not also provide the feedback control signal to the feedback providing unit 150 even though the user input is generated when the preset mode of the feedback providing apparatus 100 is a feedback removing mode.

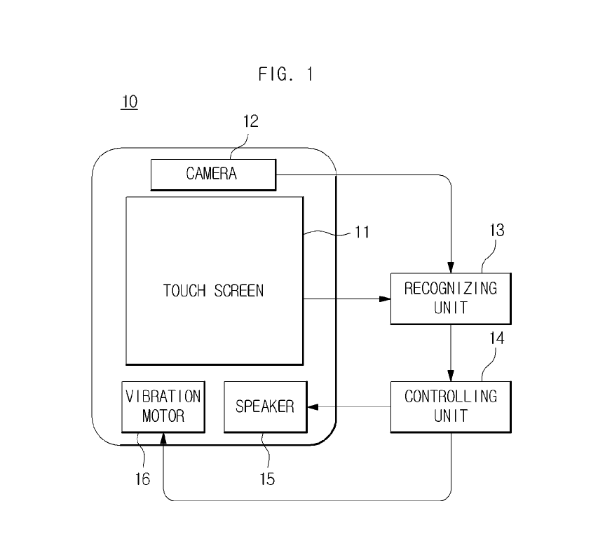

The feedback providing unit 150 includes at least one feedback providing module and provides the feedback as the sound and the vibration to the user in respond to the feedback control signal transmitted from the controlling unit 140. However, the feedback providing unit 150 according to an exemplary embodiment of the present invention may be implemented as a thin film unlike the speaker 15 or the vibration motor 16, which is an feedback providing means according to the related art shown in FIG. 1, to thereby be disposed in parallel with an upper surface or a lower surface of the touch screen 110. Since the feedback providing unit 150 may be implemented as the thin film to thereby be disposed in parallel with the upper surface or the lower surface of the touch screen, a separate space in which the feedback providing unit 150 is to be disposed is not required in the feedback providing apparatus 100. Therefore, a size of the feedback providing apparatus 100 may be decreased or a size of a display means such as the touch screen 110 may be increased. In addition, a design and manufacturing cost of the feedback providing apparatus 100 may be decreased.

Although the feedback providing unit 150 has been shown at a size smaller than that of the touch screen 110 in FIG. 2 in order to separately represent the feedback providing unit 150 and the touch screen 110, the feedback providing unit 150 may be implemented so as to have a size equal to or larger than that of the touch screen 110. That is, the size of the feedback providing unit 150 may be set regardless of the touch screen 110. However, it is preferable that the feedback providing unit 150 is implemented so as to have the size equal to that of the touch screen 110 in order to provide an accurate feedback for the user input. Since the feedback providing unit 150 may be disposed in parallel with the touch screen 110 to provide the feedback, the feedback providing apparatus 100 may provide a generally uniform feedback to the user.

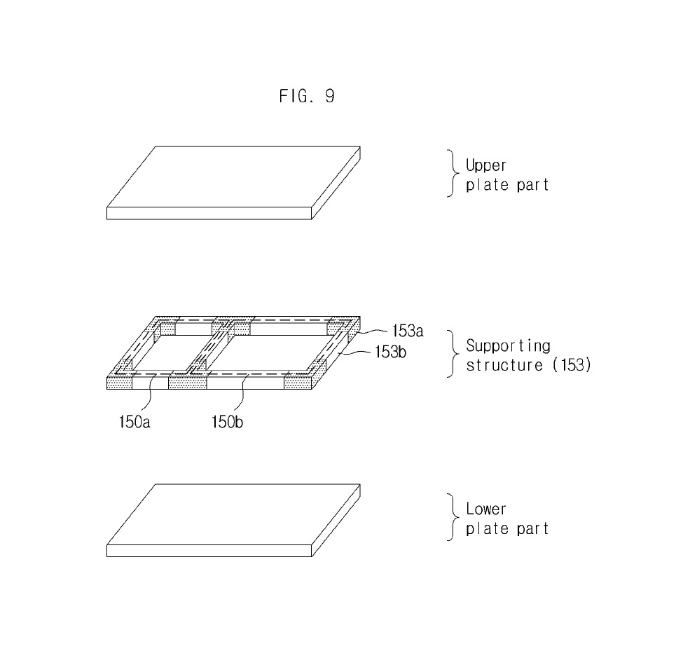

In addition, although the case in which the feedback providing unit includes one feedback providing module has been shown by way of example in FIG. 2, the feedback providing unit 150 may include a plurality of feedback providing modules disposed in a lattice form or in parallel with each other in a row on the upper surface or the lower surface of the touch screen. According to an exemplary embodiment of the present invention, as showed in FIG. 9, a size of at least one of the plurality of feedback providing modules 150a can be different from that of the other feedback providing modules 150b.

In the case in which the feedback providing unit 150 includes the plurality of feedback providing modules, the plurality of feedback providing modules may individually provide the sounds and the vibrations to the users depending on the control of the controlling unit 140. That is, since a feedback module corresponding to a position on the touch screen 110 at which the user input is generated may provide the sound and the vibration as the feedback to the user, different feedbacks may be provided depending on input positions of the users. That is, the sound and the vibration may be generated from the feedback providing module corresponding to the input position to provide the feedback, which may allow different feedbacks to be provided to the respective users in the case in which a plurality of users use the feedback providing apparatus 100. In addition, in the case in which the plurality of feedback providing modules are provided, they may individually output different sounds. Therefore, the plurality of feedback providing modules may provide the vibrations corresponding to the touch positions, but also provide different sounds for each touch position as the feedbacks.

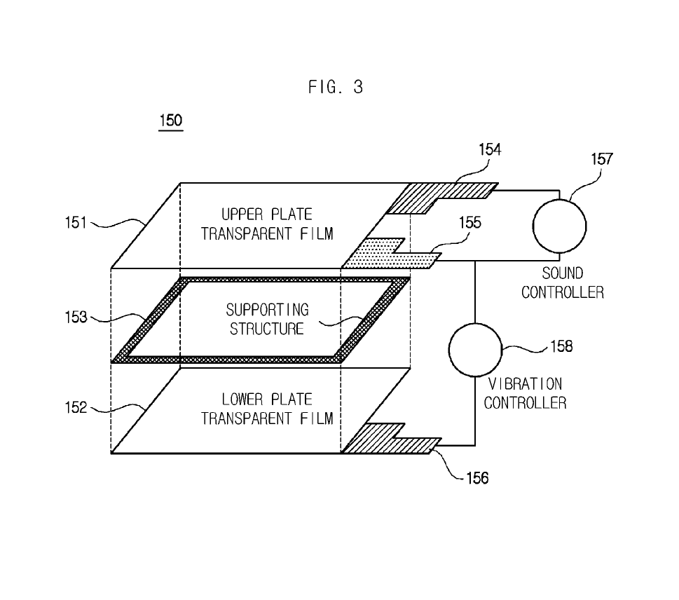

A detailed configuration of the feedback providing module will be described with reference to FIG. 3.

Although the recognizing unit 130 has been shown separately from the input means such as the touch screen 110 and the camera 120 in FIG. 2, the recognizing unit 130 may be implemented so as to be included in each of the input means. That is, a plurality of recognizing units 130 may be implemented so as to be included in input means corresponding thereto, respectively. In some cases, the recognizing unit 130 may also be implemented so as to be included in the controlling unit 140.

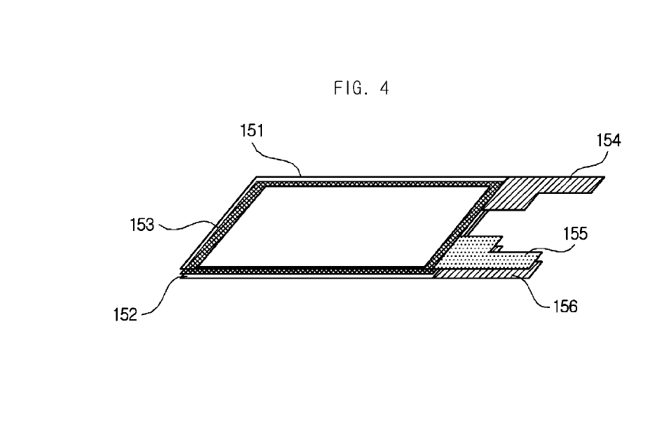

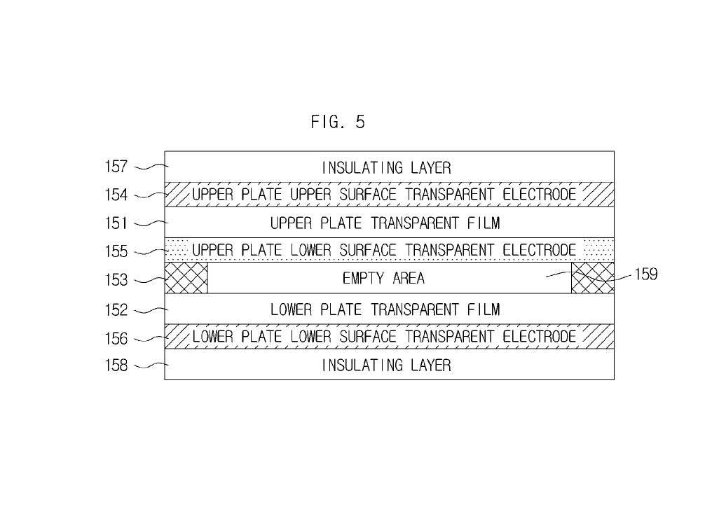

FIG. 3 is an exploded perspective view showing a detailed structure of a feedback providing module of FIG. 2; FIG. 4 is an assembled perspective view of the feedback providing module of FIG. 3; and FIG. 5 is a cross-sectional view of the feedback providing module of FIG. 3. For convenience of explanation, the case in which the feedback providing unit 150 includes one feedback providing module is shown in FIGS. 3 to 5. That is, the feedback providing unit 150 and the feedback providing module will be described as being the same as each other.

A configuration of the feedback providing module 150 will be described with reference to FIGS. 3 to 5. The feedback providing module 150 according to an exemplary embodiment of the present invention is configured to mainly include an upper plate part, a lower plate part disposed below the upper plate part, and a supporting structure 153 and a feedback controlling unit disposed between the upper plate part and the lower plate part.

The upper plate part includes an upper plate transparent film 151, an upper plate upper surface transparent electrode 154 disposed on an upper surface of the upper plate transparent film, and an upper plate lower surface transparent electrode 155 disposed on a lower surface of the upper plate transparent film. The upper plate transparent film 151 is formed of a transparent piezoelectric material. When a pressure is applied to the piezoelectric material, a potential difference is generated in the piezoelectric material, and when a potential difference is applied to the piezoelectric element, a shape of the piezoelectric material is changed. An example of the piezoelectric material configuring the upper plate transparent film includes poly vinylidene fluoride (PVDF), poly-a-glutamate, poly vinyl chloride, poly tri-fluoro ethylene, and the like.

The upper plate upper surface transparent electrode 154 and the upper plate lower surface transparent electrode 155 generate a potential difference between upper and lower surfaces of the upper plate transparent film 151 in response to first and second voltages applied from a sound controller 157 of the feedback controlling unit. That is, the upper plate upper surface transparent electrode 154 and the upper plate lower surface transparent electrode 155 may be provided in order to apply the potential difference in order to induce a change in a shape of the upper plate transparent film 151, the upper plate upper surface transparent electrode 154 may receive a first voltage applied from the sound controller 157, and the upper plate lower surface transparent electrode 155 may receive a second voltage applied from the sound controller 157 and having a level different from the first voltage. In addition, the upper plate lower surface transparent electrode 155 may receive a third voltage applied from a vibration controller 158. Although only connection parts electrically connected to the sound controller 157 have been shown without any expression on the upper plate transparent film 151 in FIGS. 3 and 4 in order to represent that the upper plate upper surface transparent electrode 154 and the upper plate lower surface transparent electrode 155 are attached to the upper plate transparent film 151, the upper plate upper surface transparent electrode 154 and the upper plate lower surface transparent electrode 155 are actually attached to the upper surface and the lower surface of the upper plate transparent film, respectively, as shown in FIG. 5.

The lower plate part includes a lower plate transparent film 152 and a lower plate lower surface transparent electrode 156 attached to a lower surface of the lower plate transparent film 152. The lower plate transparent film 152 may be formed of all kinds of transparent non-conductors, for example, a glass substrate, a plastic substrate, an optical film, and the like.

The lower plate lower surface transparent electrode 156 receives a fourth voltage applied from the vibration controller 158. The lower plate lower surface transparent electrode 156 receiving the fourth voltage applied from the vibration controller 158 generates a voltage difference together with the upper plate lower surface transparent electrode 155 receiving the third voltage, thereby inducing a change in the shape of the upper plate transparent film 151 of the upper plate part.

The upper plate upper surface transparent electrode 154, the upper plate lower surface transparent electrode 155, and the lower plate lower surface transparent electrode 158 may be formed of all transparent electrode materials, for example, an indium tin oxide (ITO), a carbon nano tube (CNT), a sliver nano wire (SW), a graphene, and the like.

The supporting structure 153 is an adhering means supporting the upper plate part. However, the supporting structure 153 allows the lower surface of the upper plate part and the upper surface of the lower plate part not to directly contact each other. That is, the supporting structure 153 allows the upper plate part and the lower plate part to be spaced apart from each other by a preset interval (for example, 1 mm) and be disposed in parallel with each other. In addition, although the case in which the supporting structure 153 is disposed at only an edge region of the upper plate part and the lower plate part has been shown in FIGS. 3 and 5, the supporting structure 153 may be disposed at only both side ends or corner regions of the upper plate part and the lower plate part. In some cases, the supporting structure 153 may also be formed as a surface having the same size as those of the upper plate part and the lower plate part. The supporting structure 153, which is a component for providing a margin so that the upper plate transparent film 151 of the upper plate part formed of the piezoelectric material may vibrate depending on the control of the sound controller 157, may be formed of any material and have any shape as long as the upper plate transparent film 151 may vibrate. For example, the supporting structure 153 may be formed of silicon, synthetic rubber, synthetic resin, or the like, that is soft and has elasticity. In some cases, the supporting structure 153 may be formed of an adhesive, a non-adhesive, a screw, or the like. In some cases, the supporting structure 153 may be formed of a transparent material. However, it is preferable that the supporting structure 153 is formed of a non-conductor so that the upper plate part and the lower plate part are not electrically connected to each other.

The size of the feedback providing module 150 may influence the amplitude or frequency response of the sound and vibration. For guaranteeing the performance within target frequency range of sound or vibration, an empty areas 159 of the feedback providing module 150 can be adjusted. The empty areas 159 can be surrounded by at least one supporting structure 153 for guaranteeing the performance According to an exemplary embodiment of the present invention, the supporting structure 153 can be composed of adhesive materials and non-adhesive materials. Depending on how strongly the supporting structure 153 attaches the upper plate part with the lower plate part, the power of the signal generated by the feedback providing module 150 differs. For instance, the greater the adhesive power of the supporting structure 153 is, the power of the signal generated through the feedback providing module 150 becomes smaller. Accordingly, as shown in FIG. 9, it is possible to have a desired level of power generated by properly combining the supporting structure 153a composed of the adhesive materials and the supporting structure 153b composed of the non-adhesive materials. The supporting structure 153a and the supporting structure 153b do not necessarily have to be rectangular shapes and do not have to be connected to each other. In an embodiment, the supporting structure 153b and the lower plate part can be attached to each other by having the adhesive material coated on the bottom side of the supporting structure 153b. Also the areas of electrodes 154, 155, 156 may be changed for the same purpose.

The feedback providing module 150 may be covered by the insulating layers 157, 158 in case that the module itself is directly touched by human hands.

The feedback controlling unit includes the sound controller 157 and the vibration controller 158. First, the sound controller 157 applies the first and second voltages corresponding to the sound feedback control signal to the upper plate upper surface transparent electrode 154 and the upper plate lower surface transparent electrode 155, respectively, in response to the sound feedback control signal among the feedback control signals received from the controlling unit 140. The sound controller 157 applies the first and second voltages having different levels to the upper plate upper surface transparent electrode 154 and the upper plate lower surface transparent electrode 155, respectively, to generate a voltage difference between the upper surface and the lower surface of the upper plate transparent film 151. In addition, the sound controller 157 varies the voltage difference between the upper surface and the lower surface of the upper plate transparent film 151.

Therefore, the change in the shape of the upper plate transparent film 151 formed of the piezoelectric material is induced depending on a voltage difference between the first and second voltages applied from the sound controller 157 to the upper plate upper surface transparent electrode 154 and the upper plate lower surface transparent electrode 155, respectively. In addition, the sound controller 157 varies the voltage difference between the first and second voltages to allow the change in the shape of the upper plate transparent film 151 to induce a vibration of ambient air, thereby generating a sound. An operation generating the sound by the vibration is similar to an operation of a general speaker, and the sound controller 157 may allow the upper plate transparent film 151 to vibrate at a frequency in an audio frequency range (20 to 20,000 Hz), thereby generating the sound. That is, the upper plate part is a component for generating the sound in the feedback providing module 150. In addition, the sound controller 157 may adjust the voltage difference between the first and second voltages so that the upper plate part may generate various preset sounds.

Meanwhile, the vibration controller 158 applies the third and fourth voltages to the upper plate lower surface transparent electrode 155 and the lower plate lower surface transparent electrode 156, respectively, in response to the vibration feedback control signal among the feedback control signals. In addition, the vibration controller 158 applies the third and fourth voltages having different levels to the upper plate lower surface transparent electrode 155 and the lower plate lower surface transparent electrode 156, respectively, to generate a voltage difference between the lower surface of the upper plate transparent film 151 and the lower plate transparent film 152, similar to the sound controller 157. In addition, the vibration controller 158 varies the voltage difference. The change in the shape of the upper plate transparent film 151 is induced by the voltage difference, and the voltage difference is varied, such that the upper plate transparent film 151 vibrates depending on the difference voltage. However, the vibration controller 158 varies the voltage difference between the third and fourth voltages so that the upper plate transparent film 151 vibrates at a low frequency of the audio frequency range or less, unlike the sound controller 157. Since the upper plate transparent film 151 vibrates at the low frequency of the audio frequency range or less, the user may not sense the vibration of the upper plate transparent film generated by the control of the vibration controller 158 as a sound. Instead, since it is easy for a person to tactilely feel the low frequency vibration, the feedback providing apparatus 100, for example, the vibration motor 16 of the feedback providing apparatus 10 according to the related art performs an operation of providing the feedback by the vibration.

Although the case in which the upper plate upper surface transparent electrode 154 and the upper plate lower surface transparent electrode 155 have the same size as the upper plate transparent film 151 has been shown by way of example in FIGS. 3 to 5, the upper plate upper surface transparent electrode 154 and the upper plate lower surface transparent electrode 155 may be implemented so as to have a size smaller than that of the upper plate transparent film 151, such that a plurality of upper plate upper surface transparent electrodes 154 and upper plate lower surface transparent electrodes 155 may be attached in a lattice form or in a row to the upper surface and the lower surface of the upper plate transparent film 151, respectively.

When the feedback providing module 150 includes the plurality of upper plate upper surface transparent electrodes 154 and upper plate lower surface transparent electrodes 155 having the size smaller than that of the upper plate transparent film 151, as described above, it may locally induce the change in the shape of the upper plate transparent film 151, such that it may provide various changed sounds as the feedback. In addition, a plurality of lower plate lower surface transparent electrodes 156 having a size smaller than that of the lower plate transparent film 152 may be provided.

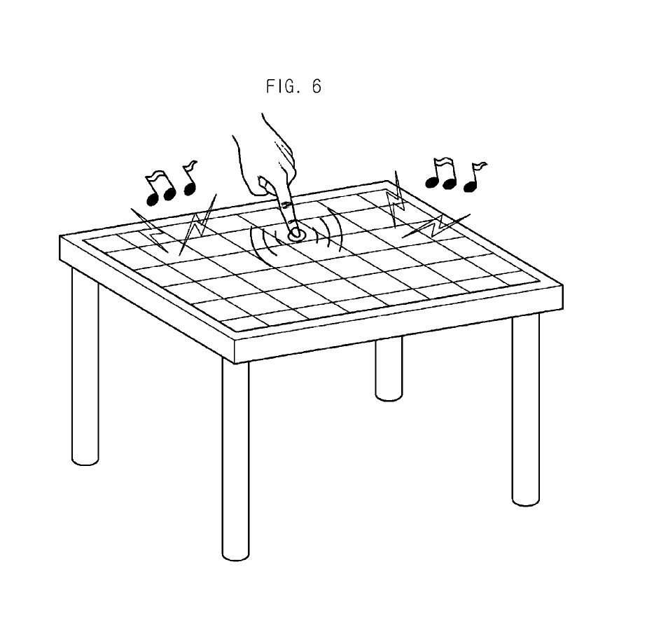

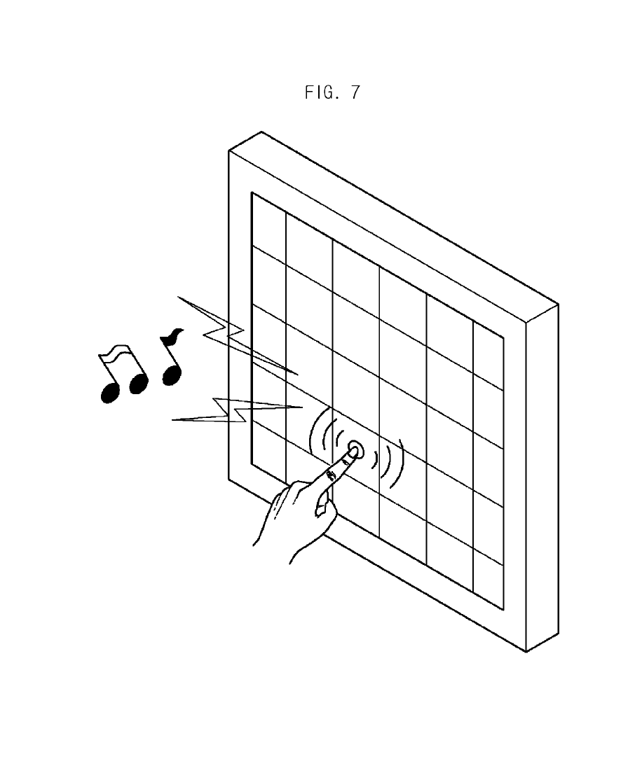

FIGS. 6 and 7 show another example of a feedback providing apparatus using the feedback providing module according to an exemplary embodiment of the present invention.

The number of feedback providing modules included in the feedback providing apparatus 100 may be only one as shown in FIGS. 3 to 5. However, in some cases, the number of feedback providing modules may be plural.

Therefore, FIG. 2 shows the case in which the feedback providing unit 150 includes one feedback providing module, while FIGS. 6 and 7 show the case in which the feedback providing unit 150 includes a plurality of feedback providing modules. Since the case in which the plurality of feedback providing modules are provided is more easily applied to a large apparatus including a surface display or a wall display than to a small apparatus, a table type surface display apparatus is shown in FIG. 6, and a wall display apparatus is shown in FIG. 7.

When the plurality of feedback providing modules are provided as described above, the plurality of feedback providing modules may individually generate sounds and vibrations. Therefore, the plurality of feedback providing modules may generate a vibration and a sound at a position corresponding to a touch position of the user and provide the generated vibration and sound as a feedback. In addition, since the respective feedback providing modules may provide vibrations and sounds having different frequencies as feedbacks, even in the case in which several users simultaneously use the feedback providing apparatus, different feedbacks may be provided to the respective users.

Therefore, the feedback providing apparatus according to an exemplary embodiment of the present invention may provide different feedbacks to multiple users, respectively, in a multi-user computer providing a large screen display such as the surface display or the wall display, Therefore, the users may individually judge accurately whether or not their commands have been input, through the feedbacks.

Further, since various sounds and vibrations may be differently provided depending on touch positions, a more realistic manipulation may be possible, and several application programs (electronic musical instrument ensemble/game) utilizing the feedback may be developed.

Although the case in which the plurality of feedback providing modules are provided has been simply described hereinabove, in the case in which the plurality of feedback providing modules are provided, the sound controller 157 and the vibration controller 158 may be integrated with each other.

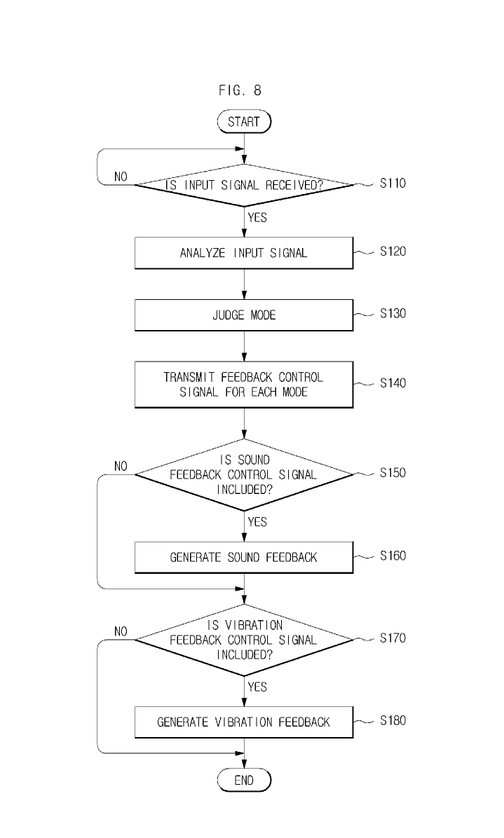

FIG. 8 is a flow chart showing a feedback providing method for providing a feedback corresponding to a user input according to an exemplary embodiment of the present invention.

The feedback providing method of FIG. 8 will be described with reference to FIGS. 1 to 7. First, the recognizing unit 130 judges whether the input signal is applied through the input means such as the touch screen 110 and the camera 120 (S110). When the input signal is not applied, the recognizing unit 130 continuously judges whether the input signal is applied (S110). However, when the input signal is applied, the recognizing unit 130 analyzes information included in the input signal (S120). As described above, the input signal includes the position information, the touch strength information, and the image information. The recognizing unit 130 transmits the analyzed recognized information to the controlling unit 140. When the controlling unit 140 receives the recognized information, it judges a preset feedback mode in the feedback providing apparatus 100 (S130). As described above, the feedback providing apparatus 100 may set the vibration feedback mode in which only the vibration feedback is provided, the sound feedback mode in which only the sound feedback is provided, the sound and vibration feedback mode in which both of the sound feedback and the vibration feedback are provided, and the feedback removing mode. Therefore, the controlling unit 140 transmits the feedback control signal to the feedback providing unit 150 depending on the preset feedback mode (S140). Here, the feedback control signal may include the vibration feedback control signal and the sound feedback control signal, and the controlling unit 140 may not transmit the feedback control signal to the feedback providing unit 150 in the feedback removing mode.

When the feedback providing unit 150 receives the feedback control signal, it judges whether the sound feedback control signal is included in the feedback control signal (S150). When the sound feedback control signal is included in the feedback control signal, the feedback providing unit 150 transmits the sound feedback control signal to the sound controller 157 included in at least one feedback providing module. Therefore, the sound controller 157 applies the first and second voltages to the upper plate upper surface transparent electrode 154 and the upper plate lower surface transparent electrode 155, respectively, to generate the voltage difference and varies the voltage difference to allow the upper plate transparent film 151 to vibrate in the audio frequency range, thereby allowing the upper plate part to generate the sound (S160).

Then, the feedback providing unit judges whether the vibration feedback control signal is included in the feedback control signal (S170). Similar to the case of generating the sound feedback, when the vibration feedback control signal is included in the feedback control signal, the feedback providing unit 150 transmits the vibration feedback control signal to the vibration controller 158 included in at least one feedback providing module. Therefore, the vibration controller 158 applies the third and fourth voltages to the upper plate lower surface transparent electrode 155 and the lower plate lower surface transparent electrode 156, respectively, to generate the voltage difference and varies the voltage difference to allow the upper plate transparent film 151 to vibrate at the low frequency lower than the audio frequency range, thereby generating the vibration (S180).

In addition, although not shown, in the case in which the feedback providing unit includes a plurality of feedback providing modules, the controlling unit 140 selects at least one of the plurality of feedback providing modules using detailed information such as the position information, the touch strength information, or the like, included in the recognized information and applies the feedback control signal to the selected feedback providing module or applies different feedback control signals to the plurality of feedback providing modules, respectively, thereby making it possible to allow the plurality of feedback providing modules to individually generate sounds or vibrations.

Therefore, in the feedback providing module, the feedback providing apparatus, and the feedback providing method according to an exemplary embodiment of the present invention, the feedback providing module may be implemented as a thin film using a transparent piezoelectric element. The feedback providing module implemented as the thin film may be easily installed regardless of a size or a shape of the feedback providing apparatus, and may simultaneously provide the sound and the vibration. In addition, since the plurality of feedback providing modules may be included in one feedback providing apparatus, different feedbacks may be provided for each input position or to each user in an apparatus used by multiple users or a system having a large size.

Therefore, with the feedback providing module, the feedback providing apparatus, and the feedback providing method according to exemplary embodiments of the present invention, a tactile function may be provided to the user using attractive force and repulsive force of electrostatic force generated between upper and lower transparent films positioned so as to be spaced apart from each other to face each other and having transparent electrodes formed thereon. In addition, power is applied between the transparent electrodes formed on both surfaces of an upper transparent piezoelectric film, such that the upper transparent piezoelectric film vibrates in an audio frequency range, thereby making it possible to transfer a sound to a user.

Further, the feedback providing module is implemented as a thin film, such that it may be disposed in parallel with an upper or lower surface of a display screen of an apparatus such as a touch screen. Therefore, a separate space in which the feedback providing module is to be disposed need not to be secured in the apparatus, such that the feedback providing module may be easily disposed even in a constraint on a size of the apparatus and facilitate a design and a manufacture of the apparatus, thereby making it possible to decrease a cost. In addition, since a plurality of feedback providing modules having a size smaller than that of a display screen may be provided and disposed, feedbacks individually corresponding to space inputs of users in an apparatus including a large display screen may be provided. Particularly, the feedback providing modules are disposed in a lattice form or in a row on an upper end of a display screen in a computing apparatus including a large display screen such as a surface display or a wall display, thereby making it possible to provide different sound and vibration feedbacks to individual users, respectively, when they manipulate the computing apparatus together or individually or when specific events are generated. Therefore, a more realistic manipulation may be possible, and several application programs (electronic musical instrument ensemble/game) utilizing the feedback may be developed.

The feedback providing method according to an exemplary embodiment of the present invention may be implemented as a computer readable code in a computer readable recording medium. A computer readable recording medium may include all kinds of recording apparatuses in which data that may be read by a computer apparatus are stored. An example of the computer readable recording medium may include a read only memory (ROM), a random access memory (RAM), a compact disk read only memory (CD-ROM), a magnetic tape, a floppy disk, an optical data striate, or the like, and also include a medium implemented in a form of a carrier wave (for example, transmission through the Internet). In addition, the computer readable recording mediums may be distributed in computer apparatuses connected to each other through a network, such that computer readable codes may be stored and executed in computer readable recording mediums in a distributed scheme.

Although the present invention has been described with reference to exemplary embodiments shown in the accompanying drawings, it is only an example. It will be understood by those skilled in the art that various modifications and equivalent other exemplary embodiments are possible from the present invention.

Accordingly, an actual technical protection scope of the present invention is to be defined by the following claims.

What is claimed is:

1. A feedback providing module comprising:
an upper plate part including a film formed of a transparent piezoelectric material and generating a vibration through a change in a shape of the film formed of the transparent piezoelectric material when first and second voltages are applied to upper and lower surfaces of the film, respectively;
a lower plate part disposed so as to be spaced apart from a lower surface of the upper plate part and inducing the vibration of the upper plate part using a voltage difference between a third voltage and a fourth voltage when the fourth voltage is applied thereto in order to generate a voltage difference from the third voltage applied to the upper plate part; and
a feedback controlling unit applying the first to fourth voltages having different levels to the upper plate part and the lower plate part in response to feedback control signals and varying the levels of the first to fourth voltages to control the upper plate part and the lower plate part to generate at least one of a sound and a vibration.

2. The feedback providing module of claim 1, wherein the feedback providing module further comprises a supporting structure inserted between the upper plate part and the lower plate part to support the upper plate part in a state in which the upper plate part and the lower plate part are spaced apart from each other by a preset interval.

3. The feedback providing module of claim 2, wherein a size of an empty areas surrounded by the supporting structure is being adjusted for guaranteeing a performance within target frequency range of sound or vibration.

4. The feedback providing module of claim 2, wherein the supporting structure is being composed of adhesive materials and non-adhesive materials.

5. The feedback providing module of claim 1, wherein the upper plate part includes:
an upper plate transparent film implemented as the film formed of the transparent piezoelectric material;
an upper plate upper surface transparent electrode disposed on an upper surface of the upper plate transparent film and receiving the first voltage; and
an upper plate lower surface transparent electrode disposed on a lower surface of the upper plate transparent film and receiving the second and third voltages.

6. The feedback providing module of claim 5, wherein the lower plate part includes:
a lower plate transparent film formed of a transparent non-conductor; and
a lower plate lower surface transparent electrode disposed on a lower surface of the lower plate transparent film and receiving the fourth voltage.

7. The feedback providing module of claim 6, wherein the feedback providing module further comprises an insulating layer on an upper plate upper surface transparent electrode and an insulating layer beneath the lower plate lower surface transparent electrode.

8. The feedback providing module of claim 6, wherein the feedback controlling unit includes:
a sound controller controlling the first and second voltage so that the upper plate transparent film vibrates in an audio frequency range, in response to a sound feedback control signal among the feedback control signals; and
a vibration controller controlling the third and fourth voltage so that the upper plate transparent film vibrates at a low frequency lower than the audio frequency range, in response to a vibration feedback control signal among the feedback control signals.

9. The feedback providing module of claim 6, wherein the upper plate transparent film is formed of one of poly vinylidene fluoride (PVDF), poly-a-glutamate, poly vinyl chloride, and poly tri-fluoro ethylene.

10. The feedback providing module of claim 6, wherein each of the upper plate upper surface transparent electrode, the upper plate lower surface transparent electrode, and the lower plate lower surface transparent electrode is formed of one of an indium tin oxide (ITO), a carbon nano tube (CNT), a sliver nano wire (SW), and a graphene.

11. A feedback providing apparatus comprising:
a feedback providing unit including at least one feedback providing module of claim 1;
an input means sensing a user input to generate an input signal;
a recognizing unit receiving and analyzing the input signal and generating recognized information for providing a feedback from the input means; and
a controlling unit judging a preset feedback mode when the recognized information is received and transmitting a feedback control signal depending on the feedback mode to the feedback providing unit.

12. The feedback providing apparatus of claim 11, wherein the feedback providing unit includes a plurality of feedback providing modules disposed in a lattice form or in a row.

13. The feedback providing apparatus of claim 12, wherein the plurality of feedback providing modules generate sounds and vibrations having different patterns, respectively.

14. The feedback providing apparatus of claim 12, wherein a size of at least one of the plurality of feedback providing modules is different from that of the other feedback providing modules.

15. The feedback providing apparatus of claim 11, wherein the feedback mode is one of a sound feedback mode, a vibration feedback mode, a sound and vibration feedback mode, and a feedback removing mode.

16. A feedback providing method by a feedback providing apparatus including a feedback providing unit including at least one feedback providing module including an upper plate transparent film implemented as a film formed of a transparent piezoelectric material and a lower plate transparent film formed of a non-conductor and disposed so as to be spaced apart from the upper plate transparent film to generate a sound and a vibration, an input means, a recognizing unit, and a controlling unit, comprising:
judging, by the recognizing unit, whether an input signal generated by the input means sensing an user input is received;
analyzing, by the recognizing unit, the input signal when the input signal is received, to transmit recognized information for providing a feedback;
judging, by the controlling unit, a preset feedback mode of the feedback providing apparatus when the recognized information is received;
transmitting, by the controlling unit, a feedback control signal depending on the judged feedback mode;
generating, by the feedback providing unit, a sound feedback by applying and controlling first and second voltages having different levels to upper and lower surfaces of the upper plate transparent film, respectively, in response to a sound feedback control signal included in the feedback control signal; and
generating, by the feedback providing unit, a vibration feedback by applying and controlling third and fourth voltages having different levels to the lower surface of the upper plate transparent film and a lower surface of the lower plate transparent film, respectively, in response to a vibration feedback control signal included in the feedback control signal.

17. The feedback providing method of claim 16, wherein the generating of the sound feedback includes:
judging, by a sound controller included in the feedback providing module, whether the sound feedback control signal is received from the controlling unit;
applying, by the sound controller, the first voltage to an upper plate upper surface transparent electrode disposed on the upper surface of the upper plate transparent film in response to the sound feedback control signal when the sound feedback control signal is received;
applying, by the sound controller, the second voltage to an upper plate lower surface transparent electrode disposed on the lower surface of the upper plate transparent film; and
varying, by the sound controller, a voltage difference between the first and second voltages so that the upper plate transparent film vibrates in an audio frequency range.

18. The feedback providing method of claim 17, wherein the generating of the vibration feedback includes:
judging, by a vibration controller included in the feedback providing module, whether the vibration feedback control signal is received from the controlling unit;
applying, by the vibration controller, the third voltage to the upper plate lower surface transparent electrode in response to the vibration feedback control signal when the vibration feedback control signal is received;
applying, by the vibration controller, the fourth voltage to a lower plate lower surface transparent electrode disposed on the lower surface of the lower plate transparent film; and
varying, by the vibration controller, a voltage difference between the third and fourth voltages so that the upper plate transparent film vibrates at a low frequency lower than the audio frequency range.

19. The feedback providing method of claim 18, wherein in the transmitting of the feedback control signal, in the case in which the feedback providing unit includes a plurality of feedback providing modules, the controlling unit transmits different feedback control signals to the plurality of feedback providing modules, respectively, so that the plurality of feedback providing modules provide feedbacks having different patterns, respectively.

20. A recording medium in which a computer readable program for performing the feedback providing method of claim 16 is recorded.
